(19) United States
(12) Patent Application Publication
(10) Pub. No.: US 2026/0305870 A1
(43) Pub. Date: Oct. 8, 2026

(54) AUTOMATED COOKING SYSTEM

(71) Applicant: ADOR Tech Inc., North York (CA)

(72) Inventor: Amirsa Amjadi, Newmarket (CA)

(21) Appl. No.: 19/637,504

(22) Filed: Apr. 2, 2026

Related U.S. Application Data
(60) Provisional application No. 63/782,437, filed on Apr. 2, 2025.

(51) Int. Cl. A47J 36/18; A23L 5/10; A47J 27/024; A47J 36/20; A47J 36/32; B25J 11/00

(52) U.S. Cl. CPC A47J 36/18; A23L 5/13; A47J 27/024; A47J 36/20; A47J 36/32; B25J 11/0045

(57) ABSTRACT

A cooking system is presented which includes a robotic arm and a pot assembly coupled to the robotic arm. The pot assembly includes a pot configured to receive food ingredients and a culinary liquid, a perforated plate disposed in the pot and separating the pot into a heating compartment and a cooking compartment, a heating element disposed in the heating compartment, a liquid conduit disposed at a lower portion of the pot, and a valve configured to control flow of the culinary liquid into and out of the pot. Heating the culinary liquid can cause the culinary liquid to pass through orifices of the perforated plate to create a mixing current in the cooking compartment. In some embodiments, the robotic arm moves the pot assembly to a serving station, a washing station, or a food ingredient dispensing system, and additives can be dispensed into cooked food in a food container.

### TECHNICAL FIELD

The present disclosure relates generally to the field of automated cooking systems and more particularly relates to a hotpot cooking robot and methods thereof.

### BACKGROUND OF THE INVENTION

The contemporary food industry, especially within the domain of restaurants and small food businesses, grapples with several significant challenges that adversely impact operation of food-preparation services. These challenges can be categorized into four main areas: the demand for fresh and desirable food, the high costs associated with human resources, constraints in available space, and the substantial initial and operational expenses of running a restaurant or food business.

Establishing a traditional restaurant requires substantial capital. Initial investments include the cost of kitchen equipment, interior setup, and other infrastructure, often making it prohibitive for new entrepreneurs and small business owners to enter the market. Traditional restaurants typically incur costs related to food, labor, and rent. These expenses make it challenging for entrepreneurs with limited capital to enter the market and for existing businesses to sustain operations efficiently. Consumers also increasingly seek fresh, high-quality, and diverse food options. The shift towards healthier eating habits and the desire for culinary diversity demand restaurants to offer a wide range of fresh and appealing dishes.

The quality of cooked food, whether at home or in restaurants, is significantly influenced by the consistency and technique used in its preparation. Proper cooking can involve control of preparation time, temperature, ingredient selection, and cooking sequence. Consistency in food preparation can be affected by various factors, including the workload of cooks who often juggle multiple tasks due to fluctuating customer demand. Food preparation is labor-intensive, making labor costs a substantial component of overall food costs in restaurants. Additionally, recruiting a sufficient number of skilled employees can be challenging in areas with limited population or in locations like highway rest stops. Maintaining multiple cooking systems at home may also be impractical for consumers seeking a diverse range of cooked foods.

The food service industry, from customer-facing operations to kitchen operations, is witnessing a growing trend toward automation. This shift is driven by the desire to streamline processes, enhance efficiency, and improve overall performance. By automating various aspects of kitchen workflow, food service establishments can reduce labor demands, improve quality control, and increase efficiency.

Accordingly, there remains a need for cooking systems that can automate preparation of meals such as hotpot or malatang meals while providing controlled ingredient handling, culinary-liquid supply, cooking, serving, and cleaning operations. There also remains a need for such systems to support more consistent preparation and to reduce reliance on manual performance of repeated kitchen tasks.

### SUMMARY

According to the first disclosed aspect a cooking system is presented. The cooking system comprises: a robotic arm; and a pot assembly coupled to the robotic arm. The pot assembly comprises: a pot configured to receive food ingredients and a culinary liquid therein; a perforated plate disposed in the pot and separating an interior of the pot into a heating compartment below the perforated plate, and a cooking compartment above the perforated plate, the perforated plate comprising a plurality of orifices configured to allow passage of the culinary liquid therethrough; a heating element disposed in the heating compartment and configured to heat the culinary liquid; a liquid conduit disposed at a lower portion of the pot and extending into the pot, the liquid conduit configured to allow the culinary liquid to flow into and out of the pot; and a valve operably connected to the liquid conduit and configured to control flow of the culinary liquid into and out of the pot.

The heating element may be configured to cause the culinary liquid to boil and thereby cause the culinary liquid to pass through the plurality of orifices of the perforated plate to create a turbulent current in the cooking compartment to mix the food ingredients.

The cooking system may further comprise a liquid supply line connected to the valve and configured to supply the culinary liquid from an external source to the pot. The cooking system may further comprise a liquid drain line connected to the valve and configured to discharge the culinary liquid from the pot. The valve may be configurable in a supply state to admit the culinary liquid into the pot, a drain state to discharge the culinary liquid from the pot, and a closed state while the food ingredients are being cooked. The culinary liquid may be discharged through the liquid drain line after the food ingredients are cooked.

The cooking system may further comprise a serving station configured to support a food container, wherein the robotic arm is configured to move the pot assembly to the serving station and dispense cooked food into the food container. The cooked food may be dispensed into the food container after the culinary liquid is discharged from the pot.

The cooking system may further comprise a washing station configured to wash the pot, wherein the robotic arm is configured to move the pot assembly to the washing station after dispensing cooked food. The washing station may comprise at least one nozzle configured to spray a fluid into the pot for washing or sanitizing the pot.

The cooking system may further comprise an additive dispensing system configured to add additives to the cooked food in the food container.

The cooking system may further comprise a user interface configured to allow a user to interact with the cooking system. The user interface may be configured to allow the user to select the food ingredients and/or a food recipe.

The cooking system may further comprise a food ingredient dispensing system configured to store and provide the food ingredients, wherein the robotic arm is configured to move the pot assembly to the food ingredient dispensing system to retrieve the food ingredients.

According to another disclosed aspect, a method for preparing a meal according to a food recipe using a cooking system comprising a robotic arm and a pot assembly coupled to the robotic arm, is provided. The method comprises: receiving, at a controller of the cooking system, an order for preparing the food recipe; receiving, at a cooking compartment of a pot of the pot assembly, food ingredients of the food recipe, wherein the pot comprises a perforated plate disposed in the pot and separating an interior of the pot into a heating compartment below the perforated plate and the cooking compartment above the perforated plate, the perforated plate comprising a plurality of orifices configured to allow passage of a culinary liquid therethrough; supplying the culinary liquid to the pot using a liquid conduit disposed at a lower portion of the pot and a valve operably coupled to the liquid conduit; causing, by the controller, the valve to close when a predetermined amount of the culinary liquid is supplied to the pot; causing, by the controller, activation of a heating element disposed in the heating compartment to boil the culinary liquid, wherein boiling the culinary liquid causes the culinary liquid to pass through the plurality of orifices and create a mixing current in the cooking compartment that mixes and cooks the food ingredients, thereby preparing the meal; and causing, by the controller, discharge of the culinary liquid from the pot after the food ingredients are cooked.

The food ingredients may be received into the pot either manually by a user or automatically by a food ingredient dispensing system. The method may further comprise using the robotic arm to move the pot assembly to the food ingredient dispensing system and automatically receiving the food ingredients from the food ingredient dispensing system.

The food recipe may be selected by a user, using a user interface that is in communication with the controller.

The method may further comprise moving the pot assembly, using the robotic arm, to a serving station and dispensing the meal into a food container at the serving station.

The method may further comprise adding an additive to the meal dispensed into the food container using an additive dispensing system.

The method may further comprise moving the pot, using the robotic arm, to a washing station and causing the pot to be washed at the washing station. The method may further comprise spraying a washing fluid into the pot at the washing station to clean the pot.

Other aspects and features will become apparent to those ordinarily skilled in the art upon review of the following description of specific disclosed embodiments in conjunction with the accompanying figures.

### BRIEF DESCRIPTION OF THE DRAWINGS

In the following, embodiments of the present disclosure will be described with reference to the appended drawings. However, various embodiments of the present disclosure are not limited to the arrangements shown in the drawings.

FIG. 1 is a front view of a cooking system of the current disclosure according to an embodiment.

FIG. 2 is a top view of the cooking system of FIG. 1.

FIG. 3 is a perspective view of the robotic arm and the pot assembly of the cooking system of FIG. 1.

FIGS. 4A and 4B are perspective and side cross-sectional views of the pot assembly of FIG. 3.

FIG. 5 is an exploded view of the pot assembly of FIG. 4A.

FIG. 6 is a schematic diagram showing a control circuit of the cooking system of FIG. 1 according to one embodiment;

FIG. 7 is a flowchart diagram showing a method for using the cooking system of FIG. 1.

FIG. 8 is a flowchart diagram showing a method for using the cooking system of FIG. 1.

### DETAILED DESCRIPTION

The present disclosure relates to a fully or semi-automated cooking system configured to prepare meals, including hotpot and malatang meals. The disclosed cooking system integrates a robotic arm with a pot assembly to perform meal-preparation operations including ingredient collection, cooking, serving, and washing.

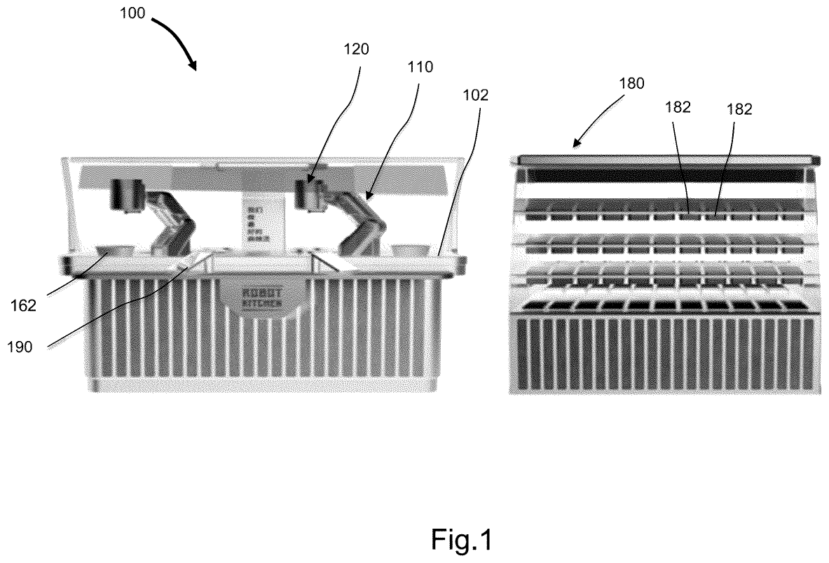

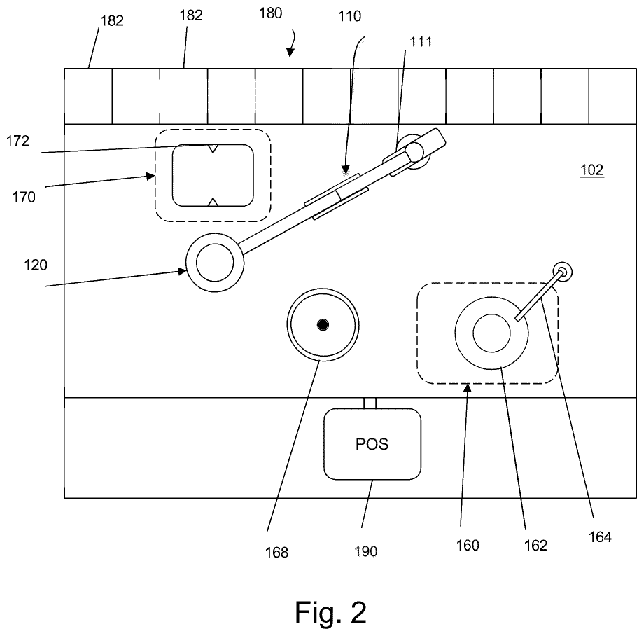

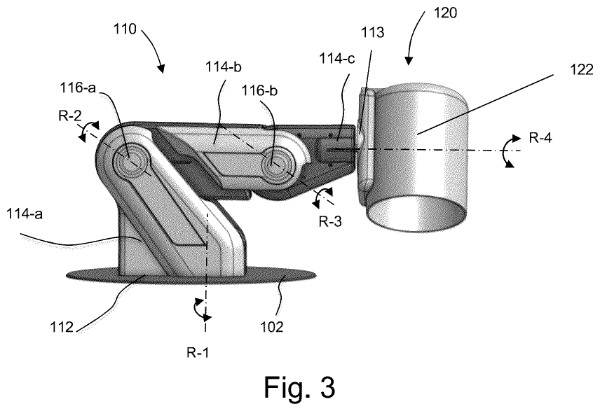

Referring to FIG. 1, a front view of a cooking system is generally shown at 100 according to a first disclosed embodiment. Referring to FIG. 2, a top view of the cooking system 100 is shown. Referring to FIGS. 1 and 2, the cooking system 100 comprises a pot assembly 120 including a pot 122 (as shown in FIG. 3) configured to receive food ingredients and a culinary liquid, according to a selected meal recipe, and to process and cook the food ingredients in the pot 122.

The pot assembly 120 is connected to a robotic arm 110 to manipulate, move, and shake the pot assembly 120 during the meal preparation. The robotic arm 110 is configured to move the pot assembly 120 between multiple stations on a working table 102 including a serving station 160, where cooked food is delivered to a user, and a washing station 170 configured to clean the pot assembly 120, for example, after cooking and preparing each meal.

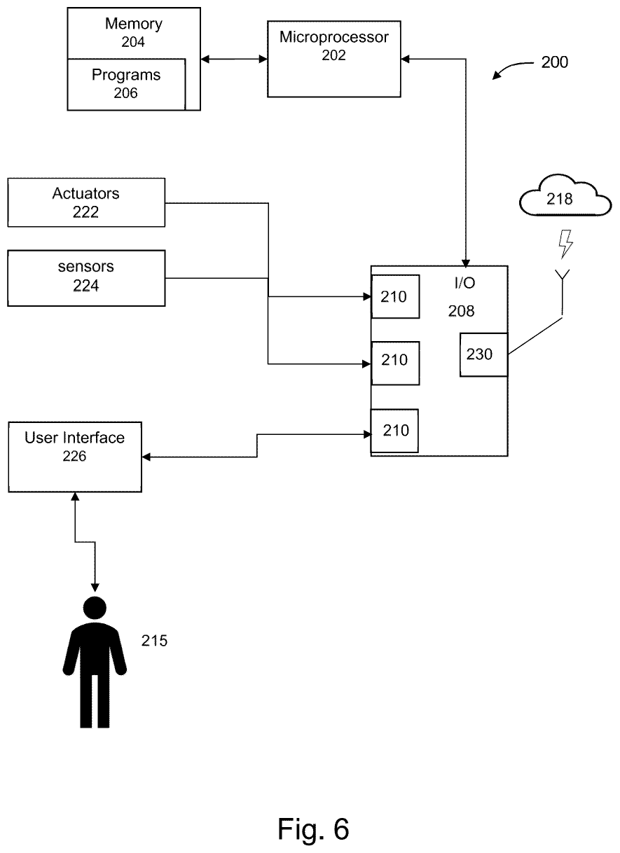

The cooking system 100 further comprises a controller (as shown by 200 in FIG. 6) configured to control operation of the cooking system 100 such as receiving an order for a meal, determining the meal recipe, determining corresponding food ingredients of the meal, receiving measurements from sensors, and sending command signals to the robotic arm 110 and to actuators of the cooking system 100.

The selected or ordered meal recipe may be calculated based on pre-programmed recipes related to selected meals by a user or may be customized recipes provided by the user. The cooking system 100 may be configured to receive the selected meal or its recipe from the user, for example using a point of sale (POS) system 190. In some embodiments, instead of the POS system 190 a user interface such as a mobile application of a mobile device (e.g., cell phone or tablet) of the user may be used to select a meal and then communicate the selected meal to the cooking system 100.

The cooking system 100 is configured to provide food ingredients and the culinary liquid, such as water and oil, into the pot 122 to help prepare the selected meal. The food ingredients and the culinary liquid can be dispensed into the pot 122 either manually (such as by a staff transferring the food ingredients to the pot 122) or automatically, for example, by the robotic arm 110 moving the pot assembly 120 to a food ingredient dispensing system 180 and then facilitating dispensing the suitable food ingredients to the pot 122 from one or more shelves 182 of the dispensing system 180. The dispensing system 180 may be equipped with multiple shelves 182 and each shelf 182 may be configured to store a respective type of food ingredient such as vegetables, proteins, noodles, or spices. The shelves 182 may be equipped with environmental controls such as temperature and humidity controls to provide and maintain suitable food storage conditions. The dispensing system 180 or each shelf 182 may further include a mechanism configured to measure and dispense a certain amount of food ingredient to the pot 122. After the food ingredients are delivered into the pot 122, the culinary liquid can be supplied to the pot 122, and then the robotic arm 110 may shake the pot 122 to sufficiently mix the food ingredients and the culinary liquid. The culinary liquid may be measured and supplied to the pot 122 manually or automatically using a controlled valve and a piping system (e.g. measuring the volume of culinary liquid using a liquid flow sensor along the piping system or using a weight sensor measuring the added weight to the pot 122 as a result of adding the culinary liquid). The suitable amount of food ingredients and the culinary liquid may be determined or calculated manually or automatically, using the controller 200, according to the corresponding recipe of the selected meal.

The cooking system 100 may further comprise a working table 102 where the robotic arm 110, the washing station 170, and the serving station 160 are disposed on. The working table 102 may further house a sink 168 configured to receive excess culinary liquid from the pot 122 after cooking the food ingredients. In some embodiments, once the cooking process is completed in the pot assembly 120, excess culinary liquid is discharged from the pot 122 before delivering the cooked meal to the users or recipients. The robotic arm 110 can be commanded by the controller 200 to move the pot assembly 120 toward the sink 168 to discharge the excess culinary liquid from inside the pot 122. Once the excess culinary liquid is discharged, the cooked food can be poured into a plate or a bowl 162 (or another form of customer container) at the serving station 160.

The robotic arm 110 can be commanded by the controller 200 to move the pot assembly 120 to the serving station 160 and dispense the cooked food from inside the pot 122 to the bowl 162. The robotic arm 110 may turn the pot 122 upside down (e.g. by rotating the pot 122 around direction R-4 as shown in FIG. 3) and shake the pot 122 to dispense the cooked meal. In other embodiments, other methods may be used to dispense the cooked meal into the bowl 162. The cooking system 100 may further include an additive dispensing module 164 to add additives, such as sauce, broth, and spices to the prepared meal in the bowl 162. The controller 200 may be configured to actuate the additive dispensing module 164 to dispense additives in the bowl 162. The additives can be selected automatically depending on the recipe of the selected meal or manually by the user by specifically indicating the desired additives when selecting their ordered meal.

The prepared meal in the bowl 162 can be delivered to the user either manually (i.e. the user picking up the bowl 162 from the serving station 160 or a staff handing the bowl 162 to the user) or automatically (e.g., on a conveyor belt, using the robotic arm 110, using a different robotic arm similar to the robotic arm 110, or using mobile autonomous robots).

After dispensing the cooked food into the bowl 162, the robotic arm 110 may be commanded by the controller 200 to move the pot assembly 120 to the washing station 170 to clean or sanitize the pot 122 with a cleaning fluid such as hot water, steam, detergents, or a combination thereof, for example. Once the pot assembly 120 reaches the washing station 170, the robotic arm 110 can rotate the pot assembly 120 upside down to an inverted position. The washing station 170 may comprise at least one nozzle 172 to spray the cleaning fluid into the pot 122. The cleaning fluid may be sprayed into the pot 122 at a relatively high pressure to remove residual food ingredients and culinary liquid. The cleaning fluid inside the pot 122 may flow back into the washing station 170 by gravity.

Referring to FIG. 3, the robotic arm 110 is fixedly connected to the working table 102 at a first end 112, and is coupled to the pot assembly 120 at a second end 113. The robotic arm 110 comprises a plurality of robotic links 114-a, 114-b, and 114-c which are coupled together via rotary joints 116-a and 116-b. In the embodiment shown in FIG. 3, the robotic arm 110 has 4 degrees of freedom provided by 4 rotary actuators (not shown in Figures) to cause rotation in R-1, R-2, R-3, and R-4 directions for the robotic links 114-a to 114-c and the pot assembly 120 respectively. In other embodiments, other types of robotic arms with different degrees of freedom and different numbers of rotary and prismatic joints may be used.

The first end 112 of the robotic arm 110 is affixed to the working table 102 while the second end 113 is able to articulate and move in three-dimensional space. To prevent collisions with objects along the working table 102, one or more collision avoidance or object detection sensors can be integrated with the robotic arm 110 to detect obstacles along the moving path of the robotic arm 110 and the pot assembly 120. For example, proximity sensors disposed on the robotic links and the pot assembly may be used, or a vision camera disposed remote from the robotic arm 110 and tracking the movement of the robotic arm 110 and the pot assembly 120. The weight and kinetics of the contents in the pot 122 may cause the robotic arm to deflect from its unloaded position, potentially leading to deviations from a preset trajectory of the pot assembly 120 and possible collision. Accordingly, the controller 200 may use control algorithms (such as motion-planning algorithms, model predictive control algorithms, and path-correction algorithms) to take into account the kinetics of the pot 122 content as well as measurement data from object detection sensors to reduce possible deviations and avoid potential collisions.

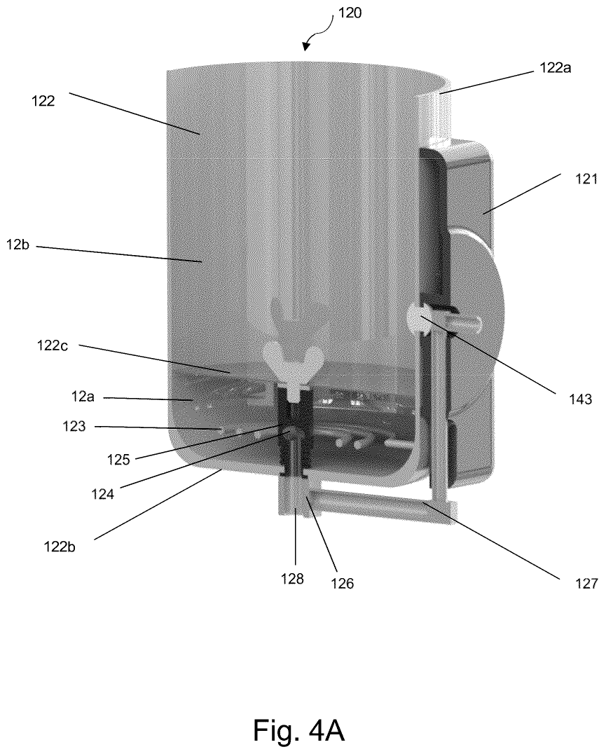

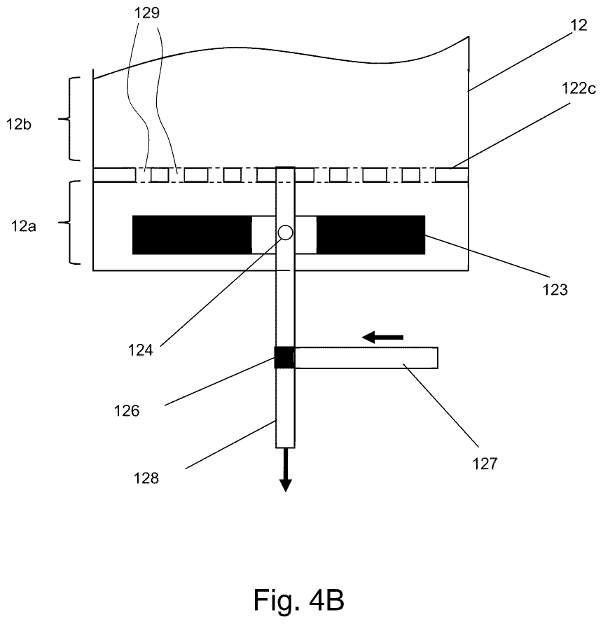

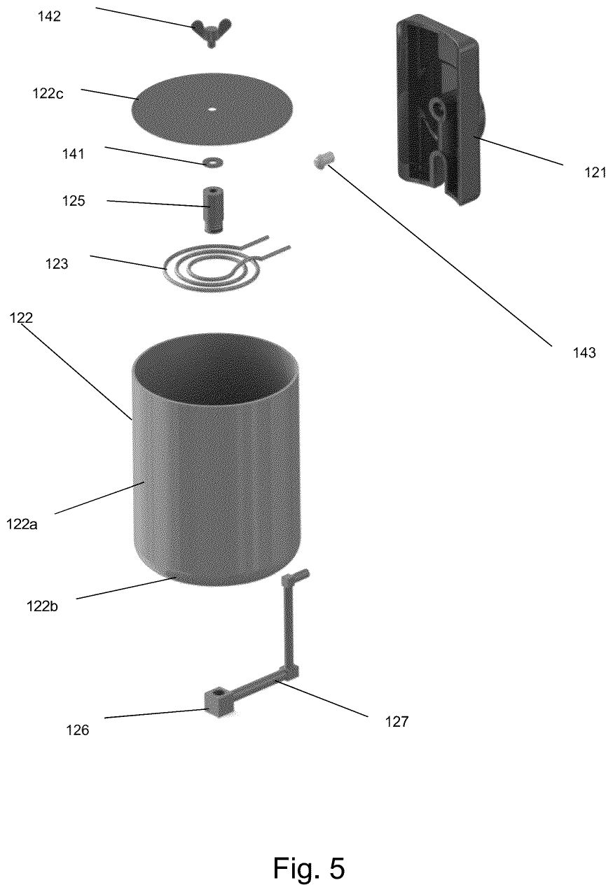

Referring to FIGS. 4A and 4B, perspective and side cross-sectional views of the pot assembly 120 are illustrated. Referring to FIG. 5, an exploded view of the pot assembly 120 is shown. Referring to FIGS. 4A and 4B, the pot 122 comprises a peripheral wall 122a and a bottom surface 122b. The space inside the pot 122 is divided into two compartments separated by a perforated plate 122c. The pot 122 includes a heating compartment 12a extending between the bottom surface 122b of the pot 122 and the perforated plate 122c, and a cooking compartment 12b extending above the perforated plate 122c for receiving and cooking the food ingredients. Thus, the perforated plate 122c is dividing the interior of the pot 122 into the heating compartment 12a and the cooking compartment 12b. The culinary liquid inside the pot 122 can move between the heating compartment 12a and the cooking compartment 12b through a plurality of small holes 129 or orifices disposed on the perforated plate 122c. Additionally, a pot flange 121 is attached to the pot 122 using a bolt 143 to facilitate coupling the pot 122 to the second end 113 of the robotic arm 110.

A liquid conduit 125 is disposed at a lower portion of the pot 122 to allow culinary liquid in and out of the pot 122 through a liquid port 124. The liquid conduit 125 is affixed to the bottom surface 122b and extends into the interior of the pot 122. The perforated plate 122c is affixed to the liquid conduit 125 using a nut 142 and a washer 141. The liquid conduit 125 is connected to a three-way valve 126 that can be controlled (e.g., using the controller 200) to supply culinary liquid to the pot 122 using a supply line 127 or to drain the culinary liquid through a drain line 128. The three-way valve 126 can be configured in a supply state in which the supply line 127 is connected to the pot 122, a drain state in which the pot 122 is connected to a drain, and a closed state in which the liquid conduit 125 is closed such that the culinary liquid cannot enter into or drain from the pot 122.

The supply line 127 is provided to guide the culinary liquid to the pot 122 through the liquid conduit 125. One end of the supply line 127 is connected to the valve 126 and the other end is coupled to an external source (not shown in figures). The culinary liquid may be sourced or supplied directly from a tap (e.g., tap water), or may be supplied from a storage source (e.g., water tank) using a pump. When the valve 126 is in the supply state, the culinary liquid flows from the external source and through the supply line 127 and the liquid conduit 125 into the pot 122.

After receiving the food ingredients in the pot 122, the culinary liquid is supplied to the pot 122 through the liquid conduit 125. The three-way valve 126 is actuated by the controller 200 to supply the culinary liquid into the pot 122. The valve 126 controls flow of the culinary liquid, and when a predetermined amount of the culinary liquid is supplied to the pot 122, the controller 200 causes the valve 126 to close to stop the flow of the culinary liquid. Once the food ingredients and the culinary liquid are inside the pot 122, the pot assembly 120 is ready for the cooking process. The predetermined amount of the culinary liquid inside the pot 122, may be determined based on a duration for which the valve 126 remains open or based on a sensor detecting an amount of liquid (e.g., liquid level, volume, or mass) within the pot 122.

The pot assembly 120 further comprises a heating element 123 disposed in the heating compartment 12a and configured to provide heat to the culinary liquid and the content of the pot 122. The heating element 123 can be a spiral-shaped coil made of high resistance material. The coil is connected to an electrical power source through terminals designed to accommodate high-temperature operation. The power supply interface includes a set of conductive leads that facilitate the electrical connection between the coil and the power source, ensuring stable current flow. The heating element 123 can also incorporate a temperature control unit (not shown), featuring a thermostat and a relay circuit, to regulate the temperature of the heating element 123. The temperature control unit can be integrated with a thermal sensor, positioned proximate to the coil, and controlled by the controller 200 to monitor real-time temperature data and adjust power input accordingly. Additionally, a safety fuse (not shown in the figures) may be included to prevent overheating and ensure safe operation under varying electrical loads. Once the heating element 123 is activated by the controller 200, the culinary liquid begins to heat up, increasing the temperature and consequently the pressure of the culinary liquid in the heating compartment 12a. The heated culinary liquid in the heating compartment 12a exchanges heat and mass with the culinary liquid in the cooking compartment 12b. As the temperature of the culinary liquid approaches its boiling point, pressurized culinary liquid is forced to pass through the plurality of small holes 129 of the perforated plate 122c at high velocity. Boiling culinary liquid passing through the plurality of small holes 129 creates a turbulent current inside the cooking compartment 12b. The turbulent current acts as a mixing mechanism to mix the food ingredients inside the cooking compartment 12b, and eliminate the need for a stirrer.

Once the cooking process of the food ingredients inside the pot 122 is complete (e.g., after a certain predetermined elapsed time), the controller 200 cuts power to the heating element 123, and then cooked food is ready to be served. Before serving the cooked food, the culinary liquid inside the pot 122 can be discharged. In this step, the controller positions the three-way valve 126 to the drain state to drain the culinary liquid from the pot 122 through the liquid conduit 125 and the drain line 128. The discharged liquid can be drained to the sink 168. Once the culinary liquid is drained from the pot 122, the cooked food is ready to be served.

As mentioned above, heat generated from the heating element 123, together with the orifices in the perforated plate 122c, facilitates creation of a turbulent flow of the culinary liquid that provides a mixing current inside the cooking compartment of the pot 122. The cooking process can be initiated by heating the culinary liquid in the heating compartment 12a such that the culinary liquid passes through the orifices into the cooking compartment 12b to mix and cook the food ingredients. This process is described in further detail below.

Referring to FIG. 6, a block diagram illustrates an embodiment of the controller 200 for the cooking system 100. The controller 200 may be preprogrammed to manage and control operational functions of respective components of the cooking system 100 via the integrated control circuitry shown in FIG. 6. This programming enables coordinated control of the cooking system 100, enhancing the efficiency and effectiveness of the cooking process.

The controller 200 may be realized through an embedded processor circuit, such as a Windows® or Linux™-operated computer. This processor circuit may either be incorporated into the cooking system 100, or it may be situated externally but connected to the cooking system 100 through either wireless or wired connections. The controller 200 comprises a microprocessor 202, a memory 204, and an input/output (I/O) interface 208, all of which are in communication with the microprocessor 202.

The Input/Output (I/O) interface 208 comprises a wireless interface 230 to facilitate the wireless reception and transmission of data communication signals between the controller 200 and a remote network or cloud computer 218. Additionally, the I/O interface 208 includes a wired network interface 210 for connecting to actuators 222 (e.g. actuators of the robotic arm 110, the three-way valve 126 actuator) and sensors 224 (e.g., joint sensors of the robotic arm 110 and temperature or pressure sensors of the pot assembly 120) of the cooking system 100. The I/O interface 208 may further be in communications with a user interface 226 which facilitates interactions between the controller 200 and a user 215 such as a customer ordering a meal, an operator operating the cooking system 100, or a manager of a restaurant who is deploying the cooking system 100. The user interface 226 may be a portable handheld device such as a touch display screen, or can be a web application, or a mobile application on a cellphone. The user interface 226 can be connected to the I/O interface 208 wirelessly or by using wired connections. In some embodiments, the user 215 may interact with the cooking system 100 through the cloud 218. The user 215 can communicate orders (such as instructions on a desired meal, list of available meal recipes, and cooking conditions) to the controller 200 and receive sensors 224 data through the user interface 226.

The controller 200 is configured to transmit command signals to the actuators, including the robotic arm actuators, to control the movement (e.g., speed and direction of rotation) of the robotic arm 110, and to adjust the orientation of the pot assembly 120. This control ensures effective motion of the pot assembly 120 through the working space between multiple stations. The command signals to the actuators may be generated by the microprocessor 202, based on manual input from the user 215 or autonomously using data from the sensors 224. Sensors 224 data facilitates the automatic, or semi-automatic determination of the movement path.

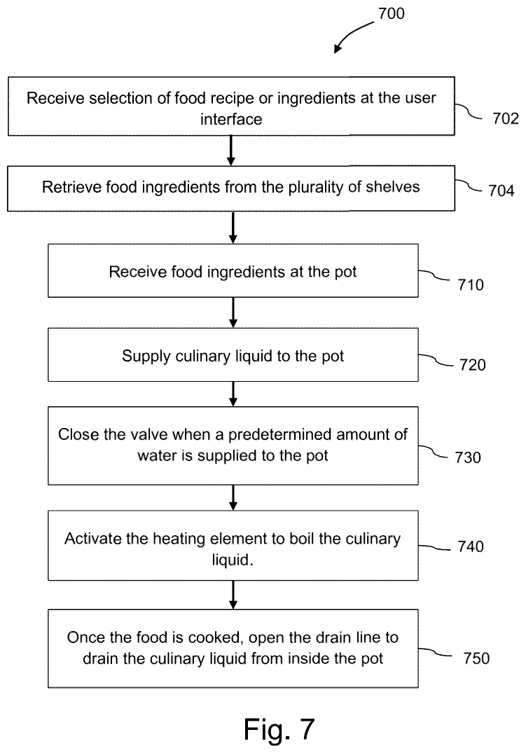

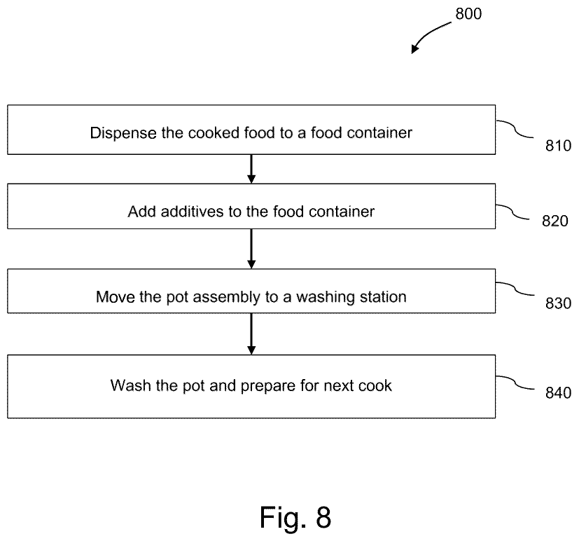

The memory 204 can store instructions in programs 206 such that, when executed by the microprocessor 202, operate the cooking system 100. Such instructions include steps and instructions included in processes 700 and 800 as described under FIGS. 7 and 8.

Referring to FIGS. 7 and 8 methods and processes for operating or instructing the operations of the cooking system 100 are provided at 700 and 800. Referring to FIG. 7, the method 700 starts at step 702 where the microprocessor receives a selection of food recipe or food ingredients from a user, for example by using the user interface 226. At step 704 the microprocessor 202 sends command signals to the robotic arm 110 to move the pot assembly 120 to the food ingredient dispensing system 180 and retrieve suitable food ingredients from the shelves 182 according to the selection of food recipe received in step 702. The robotic arm 110 is instructed to move the pot assembly 120 toward the suitable shelves 182 and retrieve the proper amount of food ingredients from each shelf 182. At step 710 the proper food ingredients according to the selected food recipe received at step 702 are received at the pot 122. At step 720, the three-way valve 126 is actuated to supply state, in response to commands sent from the microprocessor 202, to supply culinary liquid to the pot 122. At step 730, the valve 126 is actuated to the closed state (in response to commands sent from the microprocessor 202) when a predetermined amount of culinary liquid is supplied to the pot 122 (for example when the microprocessor 202 received sensory signals indicating a measurement related to a predetermined volume or mass of the culinary liquid). At step 740, the microprocessor 202 sends command signals to turn on or activate the heating element 123 to boil the culinary liquid and thereby cause the food ingredients to cook. At step 750, once the food is determined as cooked, the robotic arm 110 is instructed to move the pot assembly 120 to the sink 168 and the three-way valve 126 is actuated to the drain state to cause the culinary liquid to discharge from the pot 122 through the drain line 128. The food ingredients may be determined as cooked based on one or more cooking criteria, such as elapsed cooking time, a measured temperature of the pot 122 or the culinary liquid, a measured pressure within the pot 122, or a combination thereof. In some embodiments, the controller 200 may compare one or more measured operating parameters with stored recipe parameters to determine that the food ingredients are cooked.

Referring to FIG. 8, the method 800 presents further steps for operating the cooking system 100 after the food ingredients are cooked. At step 810, the robotic arm 110 is instructed to move the pot assembly 120 to the serving station 160 and dispense the cooked food ingredients into the bowl 162 at the serving station 160. To do so, the robotic arm 110 may rotate (e.g. by rotating around axis R-4) the pot 122 upside down to empty the cooked food from the pot 122 to the bowl 162, followed by shaking or vibrating the pot 122 to facilitate dispensing substantially all of the cooked food from the pot 122. At step 820, additional additives, such as sauce or broth, may be added to the bowl 162 according to the selected recipe received at step 702. At step 830, the robotic arm 110 is instructed to move the pot assembly 120 to the washing station 170. At step 840, the pot 122 is cleaned at the washing station 170 and is made ready for a subsequent cooking cycle. At this step the robotic arm 110 may move the pot 122 upside down while cleaning water, steam, or detergent are sprayed into the pot 122 to clean the pot 122 from the remnants of food.

While specific embodiments have been described and illustrated, such embodiments should be considered illustrative only and not as limiting the disclosed embodiments as construed in accordance with the accompanying claims.

1. A cooking system, comprising:
a robotic arm; and
a pot assembly coupled to the robotic arm, the pot assembly comprising:
a pot configured to receive food ingredients and a culinary liquid therein;
a perforated plate disposed in the pot and separating an interior of the pot into a heating compartment below the perforated plate, and a cooking compartment above the perforated plate, the perforated plate comprising a plurality of orifices configured to allow passage of the culinary liquid therethrough;
a heating element disposed in the heating compartment and configured to heat the culinary liquid;
a liquid conduit disposed at a lower portion of the pot and extending into the pot, the liquid conduit configured to allow the culinary liquid to flow into and out of the pot; and
a valve operably connected to the liquid conduit and configured to control flow of the culinary liquid into and out of the pot.

2. The cooking system of claim 1, wherein the heating element is configured to cause the culinary liquid to boil and thereby cause the culinary liquid to pass through the plurality of orifices of the perforated plate to create a turbulent current in the cooking compartment to mix the food ingredients.

3. The cooking system of claim 1, further comprising a liquid supply line connected to the valve and configured to supply the culinary liquid from an external source to the pot.

4. The cooking system of claim 1, further comprising a liquid drain line connected to the valve and configured to discharge the culinary liquid from the pot.

5. The cooking system of claim 1, wherein the valve is configurable in a supply state to admit the culinary liquid into the pot, a drain state to discharge the culinary liquid from the pot, and a closed state while the food ingredients are being cooked.

6. The cooking system of claim 4, wherein the culinary liquid is discharged through the liquid drain line after the food ingredients are cooked.

7. The cooking system of claim 1, further comprising a serving station configured to support a food container, wherein the robotic arm is configured to move the pot assembly to the serving station and dispense cooked food into the food container.

8. The cooking system of claim 7, wherein the cooked food is dispensed into the food container after the culinary liquid is discharged from the pot.

9. The cooking system of claim 1, further comprising a washing station configured to wash the pot, wherein the robotic arm is configured to move the pot assembly to the washing station after dispensing cooked food.

10. The cooking system of claim 9, wherein the washing station comprises at least one nozzle configured to spray a fluid into the pot for washing or sanitizing the pot.

11. The cooking system of claim 7, further comprising an additive dispensing system configured to add additives to the cooked food in the food container.

12. The cooking system of claim 1, further comprising a user interface configured to allow a user to interact with the cooking system.

13. The cooking system of claim 12, wherein the user interface is configured to allow the user to select the food ingredients and/or a food recipe.

14. The cooking system of claim 1, further comprising a food ingredient dispensing system configured to store and provide the food ingredients, wherein the robotic arm is configured to move the pot assembly to the food ingredient dispensing system to retrieve the food ingredients.

15. A method for preparing a meal according to a food recipe using a cooking system comprising a robotic arm and a pot assembly coupled to the robotic arm, the method comprising:
receiving, at a controller of the cooking system, an order for preparing the food recipe;
receiving, at a cooking compartment of a pot of the pot assembly, food ingredients of the food recipe, wherein the pot comprises a perforated plate disposed in the pot and separating an interior of the pot into a heating compartment below the perforated plate and the cooking compartment above the perforated plate, the perforated plate comprising a plurality of orifices configured to allow passage of a culinary liquid therethrough;
supplying the culinary liquid to the pot using a liquid conduit disposed at a lower portion of the pot and a valve operably coupled to the liquid conduit;
causing, by the controller, the valve to close when a predetermined amount of the culinary liquid is supplied to the pot;
causing, by the controller, activation of a heating element disposed in the heating compartment to boil the culinary liquid, wherein boiling the culinary liquid causes the culinary liquid to pass through the plurality of orifices and create a mixing current in the cooking compartment that mixes and cooks the food ingredients, thereby preparing the meal; and
causing, by the controller, discharge of the culinary liquid from the pot after the food ingredients are cooked.

16. The method of claim 15, wherein the food ingredients are received into the pot either manually by a user or automatically by a food ingredient dispensing system.

17. The method of claim 16, further comprising using the robotic arm to move the pot assembly to a food ingredient dispensing system and automatically receiving the food ingredients from the food ingredient dispensing system.

18. The method of claim 15, wherein the food recipe is selected by a user, using a user interface that is in communication with the controller.

19. The method of claim 15, further comprising moving the pot assembly, using the robotic arm, to a serving station and dispensing the meal into a food container at the serving station.

20. The method of claim 19, further comprising adding an additive to the meal dispensed into the food container using an additive dispensing system.
